(19) United States
(12) Patent Application Publication
(10) Pub. No.: US 2008/0135328 A1
(43) Pub. Date: Jun. 12, 2008

(54) Noise reduction device

(75) Inventors: Shoichi Takeda, Chikuma-shi (JP); Yukito Obinata, Nagano-shi (JP); Tsuyoshi Arai, Nagano-shi (JP); Naoki Gohdo, Chikuma-shi (JP); Yoshiyuki Takizawa, Chikuma-shi (JP); Yuuki Nakamura, Nakano-shi (JP)

Correspondence Address: STAAS & HALSEY LLP, SUITE 700, 1201 NEW YORK AVENUE, N.W., WASHINGTON, DC, 20005, US

(73) Assignee: MK SEIKO CO., LTD., Nagano-ken (JP)

(21) Appl. No.: 11/889,813

(22) Filed: Aug. 16, 2007

(30) Foreign Application Priority Data
Dec. 7, 2006 (JP) 330242/2006

(51) Int. Cl. F01N 1/06; F16F 15/00

(52) U.S. Cl. 181/206; 181/208

(57) ABSTRACT

A plurality of openings are provided on the surface of a body casing which comprises a noise reduction chamber, and plate members (a reflecting plate and a sound waves introduction plate) are provided extending from an edge of each opening to the noise reduction chamber. The opening edges at which these plate members are attached have acute corners or rounded corners.

### BACKGROUND OF THE INVENTION

1. Field of the Invention

The present invention relates to a noise reduction device which is mainly attached to the upper portion of a barrier body and which reduces noise generated by a noise source.

2. Description of the Related Art

Previously, providing a noise barrier is well known as one means for blocking noise generated by noise sources such as an automobile or a construction site. With these noise barriers, a barrier body, formed from a translucent resin plate or a metal part, is disposed on the shoulder of a road or in the vicinity of a construction site, and the noise barrier is designed so that noise generated on one side of the barrier body is not directly transmitted to the other side of the barrier body. The taller the noise barrier the greater the sound insulation effect, thus the trend is for noise barriers to become taller as buildings in urban areas tend towards high rises. However, making noise barriers taller raises building costs and maintenance costs, and the noise barriers are an impediment to sunshine in the surrounding areas. For these reasons, there is a demand to limit the height of noise barriers as much as possible and also to raise the sound insulation characteristics thereof.

For example a disclosure is made, in Japanese Patent Application Laid-Open No. 2005-31599, of a noise reduction device to be attached to the upper portion of a noise barrier. This noise reduction device is composed of a sound reflecting plate, a diffraction suppression plate and a sound interference device, and the sound energy can be reduced by directing the noise sound waves, which reach the noise reduction device from the noise source, to the sound interference device through the effects of both the sound reflecting plate and the diffraction suppression plate. In the above patent document, sound waves that would travel around to the back side of the noise barrier by diffracting at the upper portion of the noise barrier are captured by the diffraction suppression plate constituting the noise reduction device and the captured sound waves are guided into the sound interference device along the diffraction suppression plate. On the other hand, sound waves that are not captured by the diffraction suppression plate are guided to the sound interference device due to reflection from the sound reflecting plate, which has a cross section of an elliptical shape.

In the above patent document, the sound reflecting plate, having a cross section of a portion of an ellipse, and the diffraction suppression plate, which comprises a diffraction edge, form a sound incidence surface, and noise sound waves which enter the sound incidence surface impact the diffraction edge to cause a diffraction phenomenon. Here, the diffraction suppression plate can not capture noise sound waves until a diffraction phenomenon occurs. Accordingly, causing diffraction in the noise sound waves at the diffraction edge of the diffraction suppression plate is important to obtain a noise reduction effect. However, in the above patent document, an explanation is given of causing a diffraction phenomenon from the impact of noise sound waves on the diffraction edge, however, no explanation is given of a structure or shape for effectively generating the diffraction phenomenon.

Furthermore, in the above patent document, noise sound waves which passed through without impacting the diffraction edge of the diffraction suppression plate is captured by the sound reflecting plate. This sound reflecting plate comprises a cross section of an elliptical shape and its positional relationship with the diffraction suppression plate is determined on the basis of the position of the noise source. As a result, a mold for forming a cross section of an elliptical shape in the sound reflecting plate is necessary, and construction costs rise, and furthermore, when the position of the noise source deviates from the predetermined design position, sufficient noise reduction effects cannot be obtained.

### SUMMARY OF THE INVENTION

The present invention is designed to solve these types of problems, and an object of the present invention is to provide a noise reduction device, which is disposed on the upper portion of a noise barrier or the like, which is a device for reducing noise by capturing noise sound waves by using both sound diffraction and sound reflecting phenomena, which can generate an effective diffraction phenomenon to cause a noise reduction effect, and which can obtain a noise reduction effect without influencing the relative positional relationships of the noise reduction device and the noise source.

In order to achieve the above object, the first aspect of the present invention relates to a noise reduction device for reducing the sound pressure of noise arriving from a noise source, comprising: a body casing which comprises a space having a predetermined volume on an inner side thereof; a noise reduction chamber which is formed in the inner side space of the body casing, and which houses sound absorbing material; and a plurality of plate members extending, in the inner portion of the body casing, from the noise reduction chamber to the front surface of the body casing. An opening, formed by one plate member and another plate member facing that one plate member, communicates with the noise reduction chamber from the front surface of the body casing, and the cross section of an edge portion of the opening is shaped to have a corner that can generate a diffraction phenomenon for a sound wave.

The cross-section shape of the edge portion of the opening may have an acute corner shape or a rounded corner shape.

The plate members may be structured so that the cross section of the plate members is a continuous curve, so that the cross section of the plate members is an approximate curve formed by consecutively bending a straight line, or so that the plate members are flat plates having at least one bent portion.

In the noise reduction device according to the first aspect present invention, a plurality of openings are provided on the surface of the body casing comprising the noise reduction chamber, and the plate members are provided extending from the opening edge portion of the opening to the noise reduction chamber. The shape of the opening edge portion at which the plate members are attached is formed having a corner. Accordingly, when noise sound waves arrive from a noise source, the noise sound waves impact the opening edge portion and effectively generate a diffraction phenomenon at the corner portion, then the diffracted sound waves are guided into the noise reduction chamber along the surface of the plate members to obtain a noise reduction effect. Particularly, by making the shape of the corner acute it is possible to generate a reliable diffraction phenomenon, however, even with a rounded corner it is possible to generate a diffraction phenomenon. In the case of employing a rounded corner, safety is improved by eliminating the edge portion having an acute corner even though the efficiency of generating a diffraction phenomenon is reduced.

Moreover, by forming the cross sectional shape of the plate members as a continuous curve, it is possible to guide the noise sound waves, diffracted at the opening edge portion, into the noise reduction chamber with high efficiency. Furthermore, even if the cross sectional shape of the plate members is formed having an approximate curve, an effect can be obtained to guide the noise sound waves into the noise reduction chamber. Here, an ‘approximate’ curve is a shape formed by bending one straight line at a plurality of locations, and a curve formed by connecting the apices of a plurality of bent portions serves as a desired curve in this case. Accordingly, the actual cross sectional shape of the plate member is not a continuous curve but is a non-continuous curve of connected straight line portions with the angles between the portions varying, however, guiding sound waves that caused a diffraction phenomenon at the opening edge portion to the noise reduction chamber in this case is not inferior to the case of the continuous curve. In the case of the non-continuous curve, it is possible to perform bending processing of the plate material using sheet metal working machinery, thus a mold for forming a curve is unnecessary and the reduction in manufacturing costs is significant. Moreover, even if the above plate members are structured by bending a flat plate in at least one location, it is possible to obtain an effect of guiding noise sound waves such as those described above into the noise reduction chamber. In this case, it is possible to reduce the bending processing for the plate members and greatly reduce the manufacturing cost.

The second aspect of the present invention relates to a noise reduction device for reducing the sound pressure of noise arriving from a noise source, comprising: a body casing which comprises a space having a predetermined volume on an inner side thereof; a noise reduction chamber which is formed in the inner side space of the body casing, and which houses sound absorbing material; and pairs of plate members each extending, in the inner portion of the body casing, from the noise reduction chamber to the front surface of the body casing. Plate members that constitute a pair are joined together at the tip ends thereof to form a V shape and are disposed in the body casing such that the tip ends of the paired plate members face the front surface side of the body casing and the rear ends of the paired plate members face the noise reduction device side, and an opening formed by one plate member of a pair of plate members and one plate member in an adjoining pair of plate members communicates with the noise reduction chamber from the front surface of the body casing, and the cross sectional area of this opening gradually becomes smaller from an edge portion of the opening towards the noise reduction chamber rearwards.

In the noise reduction device according to the second aspect of the present invention, a plurality of plate members are attached to each edge portion of a plurality of openings provided in the body casing which comprises the noise reduction chamber, facing the inner portion of the noise reduction chamber. When making the above attachment, the plurality of plate members form V-shaped cross sections with the apices thereof being the edge portions of the openings, and grooves are formed in a manner such that it narrows from the edge portions of the openings toward the noise reduction chamber. Thus the outer and inner portions of the noise reduction chamber communicate through the base portion of the groove. Also, edges are formed on the edge portions of the openings at the tip ends where the end portions of pairs of the plurality of plate members are joined. Furthermore, these openings are designed to maintain a wide area on the front side of the body casing with the area of the opening gradually narrowing towards the inner portion of the noise reduction chamber. Accordingly, the noise sound waves arriving from the outer portion enter the noise reduction chamber, while repeatedly reflecting on the wall surfaces of the groove which gradually narrows, after entering from the openings. Once the noise sound waves enter the noise reduction chamber, the noise sound waves are inhibited from leaking out to the outer portion (or to the surface side of the body casing), since the area of the openings at the inner portion of the noise reduction chamber is small as compared with the area of the openings at the surface of the body casing.

As the noise reduction device according to the present invention comprises the above structure, the relative positions of the noise source and the noise reduction chamber have no influence on the noise reduction effect whatsoever, thus a noise reduction effect can be obtained irrespective of the position of the noise source.

### BRIEF DESCRIPTION OF THE DRAWINGS

The forgoing and other objects and feature of the invention will be apparent from the following description of preferred embodiments of the invention with reference to the accompanying drawings, in which:

FIG. 1 shows a noise reduction device according to a first embodiment of the present invention in a state where it is used;

FIG. 2 shows a vertical cross section of the noise reduction device of FIG. 1;

FIG. 3A shows a first example of a cross sectional shape of a reflecting plate in the noise reduction device of FIG. 2;

FIG. 3B shows a second example of a cross sectional shape of a reflecting plate in the noise reduction device of FIG. 2;

FIG. 4A is an enlarged cross sectional view of a first example of an opening edge of an opening in the noise reduction device, with a cross section of the opening edge having an acute corner;

FIG. 4B is an enlarged cross sectional view of a second example of an opening edge of an opening in the noise reduction device, with the opening edge being formed from a cap having a cross sectional acute corner;

FIG. 5A is an enlarged cross sectional view of a third example of an opening edge of an opening in the noise reduction device, with the cross section of the opening edge having a rounded corner;

FIG. 5B is an enlarged cross sectional view of a fourth example of an opening edge of an opening in the noise reduction device, with the opening edge being formed from a cap having a cross sectional rounded corner;

FIG. 6 is an explanatory drawing showing a vertical cross section of the noise reduction device according to a second embodiment of the present invention; and

FIG. 7 is an explanatory drawing showing a vertical cross section of the noise reduction device according to a third embodiment of the present invention.

### DESCRIPTION OF THE PREFERRED EMBODIMENTS

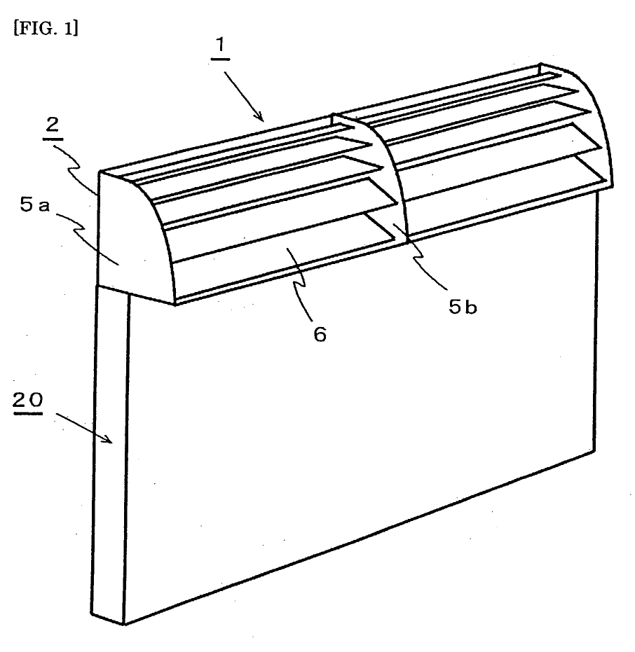

At first, an explanation will be given of a first embodiment of a noise reduction device of the present invention using FIGS. 1 to 5B.

FIG. 1 shows a noise reduction device according to a first embodiment of the present invention in a state where it is used.

A noise reduction device 1, as shown in FIG. 1, is disposed on the upper portion of a noise barrier 20 and along the width direction of that noise barrier 20. This noise reduction device 1 is composed of a body casing 2 and a plurality of openings 6. The body casing 2 has a hollow structure in the lateral direction, and the vertical cross section thereof is substantially fan shaped. The openings 6 each have a horizontally rectangular shape and are formed on the front surface of the body casing 2 (on the surface on the side facing the noise source). A noise reduction chamber 9 for reducing the energy of noise sound waves entering from the openings 6 is provided in the body casing 2.

When the noise reduction device 1 is disposed on the upper portion of the noise barrier 20, an arc portion of the fan shaped cross section of the body housing 2 faces a noise source (not shown). A plurality of openings 6 are formed along the portion of the fan shaped cross section of the body housing 2, as a result, the openings 6 can receive sound waves generated by the noise source.

Noise sound waves that impact the noise barrier 20, from among the noise sound waves generated by the noise source, are reflected in the direction of the noise source. In this case, the wavelengths of low tone sound waves included in the noise are sufficiently long relative to the height of the noise barrier 20 (for example, a sound wave at 100 Hz has a wavelength of about 3.4 meters, and the height of a noise barrier may be about 2 meters), thus a diffraction phenomenon is caused on the upper portion of the noise barrier 20 and sound travels around to the back side of the barrier. At this time, the noise reduction device 1 is disposed on the upper portion of the noise barrier 20, as shown in FIG. 1, as a result, this noise reduction device 1 captures the sound waves that would travel around to the back side of the barrier and those sound waves are guided into the noise reduction chamber from the openings 6 of the noise reduction device 1, where noise reduction is performed by reducing the energy of the sound waves. Of course it is also possible to reduce noise by capturing noise sound waves that directly reach the noise reduction device 1 from the noise source, thereby eliminating that sound.

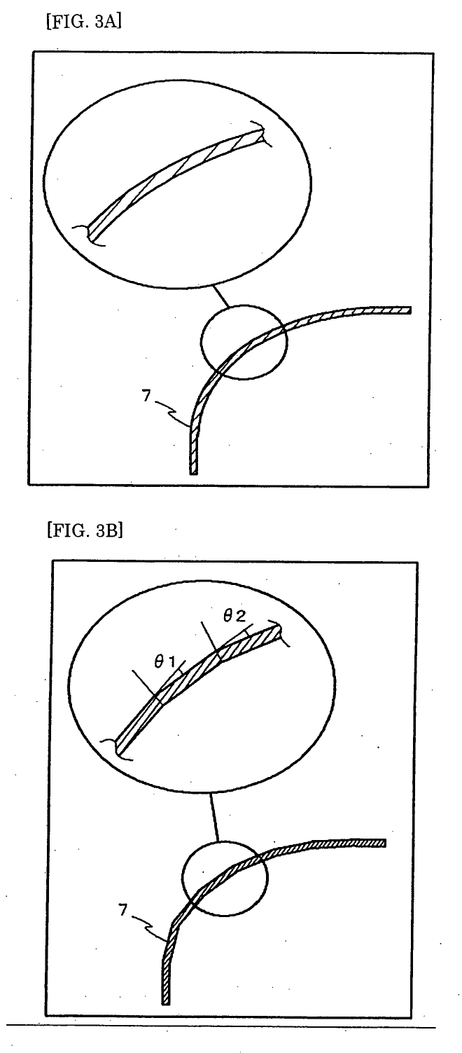

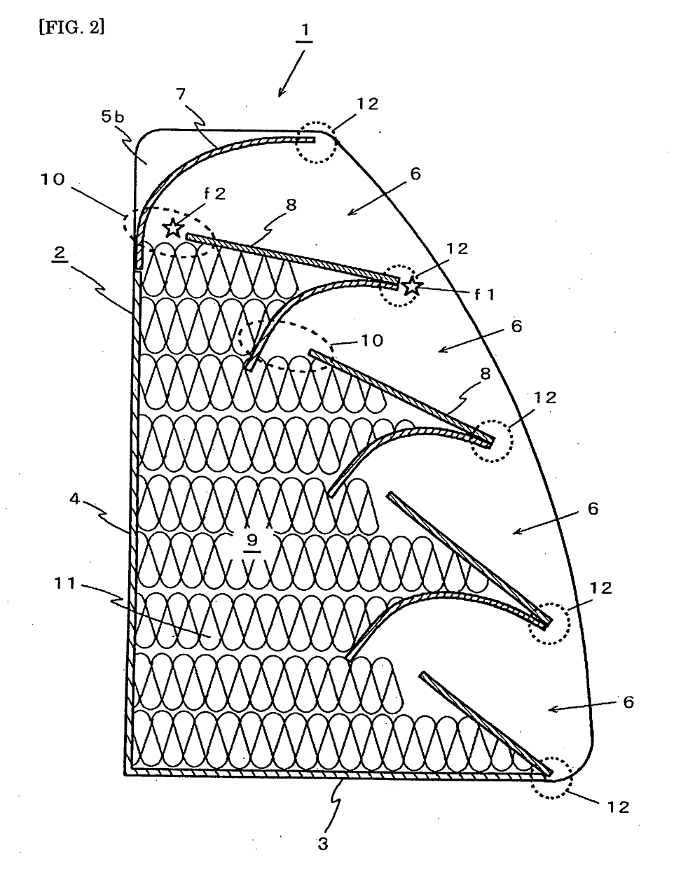

Next a detailed explanation will be given of the structure of the noise reduction device 1 using FIG. 2.

The body casing 2 of the noise reduction device 1 is structured by, as shown in FIG. 2, a base plate 3 that forms the base surface, a back plate 4 that forms the back surface, and fan shaped side plates 5a and 5b that form the left and right end surfaces. Furthermore, on the front surface from the upper portion of the body casing 2 to the front portion (portion on the side opposite the back plate 4) (in other words the front surface of the noise reduction device 1), a plurality of openings 6 are provided along the arc of the side plates 5a and 5b.

Each opening 6 provided on the front surface of the noise reduction device 1 is formed by two plate members of differing shapes, a reflecting plate 7 and a sound waves introduction plate 8, so that it has a horizontally long shape. Note that reference numeral 12 in FIG. 2 denotes the edge of the openings 6. On the side opposite the edges 12 of these openings 6, the respective rear end portions of the reflecting plate 7 and the sound waves introduction plate 8 faces each other with a gap between them so that sound waves introduction openings 10 leading to the noise reduction chamber 9 are formed.

The noise reduction chamber 9, which communicates with the openings 6 via these sound waves introduction openings 10, is formed by filling a space constituted by the base plate 3, the back plate 4 and the side plates 5a and 5b, forming the body casing 2, and also the reflecting plates 7 and the sound waves introduction plates 8, forming the openings 6, with sound absorbing material 11 made from a fibrous material such as glass wool or a porous material such as urethane.

In this manner, the noise sound waves that reach the noise reduction device 1 cause a diffraction phenomenon by impacting the edges 12 of the openings 6. Then the edge 12 of each of these openings 6 serves as a new sound source, and the sound wave from the new sound source enters the noise reduction chamber 9 through the sound waves introduction openings 10 while diffracting along the front surface of the sound waves introduction plates 8. The noise sound waves that enter the noise reduction chamber 9 repeatedly reflect irregularly within the noise reduction chamber 9 so that the reflected waves cancel their energy each other or impact the sound absorbing material 11, thereby reducing the energy of the sound waves. As a result the sound pressure energy of the noise sound waves is greatly reduced and a noise reduction effect is obtained.

Next an explanation will be given of the shape and the position of the reflecting plates 7 and the sound waves introduction plates 8 that constitutes the openings 6.

The reflecting plates 7 are each formed such that the cross section thereof has a curve of an elliptical shape, as shown in FIG. 2. The front ends of the sound waves introduction plates 8 which, along with these reflecting plates 7, form the openings 6, are positioned at focal points f1 which are found on one end of the ellipse of the reflecting plates 7, and the rear ends of the sound waves introduction plates 8 are positioned at focal points f2 which are found on the other end of the ellipse of the reflecting plates 7. These sound waves introduction plates 8 are made of flat plate shaped material. Furthermore, the front end (positioned at one focal point f1) of one sound waves introduction plate 8 which forms one opening 6 and the front end of one reflecting plate 7 which forms another opening 6 immediately below the one opening 6 are joined to each other with the tip ends thereof aligned, thereby forming the edge 12 of the one openings 6. On the other hand, the rear end of one sound waves introduction plates 8, positioned at the focal point f2, forms, along with the rear end portion of a reflecting plate 7, one sound waves introduction opening 10.

By structuring and disposing the reflecting plates 7 and the sound waves introduction plates 8, which together form the openings 6, as described above, the noise sound waves that impact the edges 12 of the openings 6, which becomes new sound sources due to the Huygens' Principle. Then, the sound waves generated here become spherical waves and head from the edges 12 of the openings 6 towards the reflecting plates 7. When these sound waves are reflected by the reflecting plates 7, the noise sound waves gather at the sound waves introduction openings 10.

Furthermore, the sound waves introduction plates 8 extend from the edges 12 of the openings 6 (positioned at the focal points f1) to the sound waves introduction openings (positioned at the focal points f2) so that the opening area of each sound waves introduction opening 10 is smaller than the opening area of each opening 6. Hence, sound waves which once entered the noise reduction chamber 9 are inhibited from leaking out to the outer portion of the noise reduction chamber 9.

The reflection plates 7 may be fabricated from a flat plate using a mold, so that the cross section thereof, as shown in FIG. 3A, is a continuous elliptical curve, or, as shown in FIG. 3B, the reflection plate 7 may be processed (with sheet metal processing) from a flat plate by making many bends, so that the cross section thereof, is approximately a curve of an elliptical shape. When the cross section of the reflecting plates 7 is a continuous elliptical line, the range of the focal points f1 and f2 of the ellipse is narrow, however, when the cross section is approximately an elliptical curve (a curve formed by bending a straight line), the range of the focal points f1 and f2 of the ellipse is slightly widened and ambiguous, but still sufficiently at the allowable level to obtain a noise reduction effect.

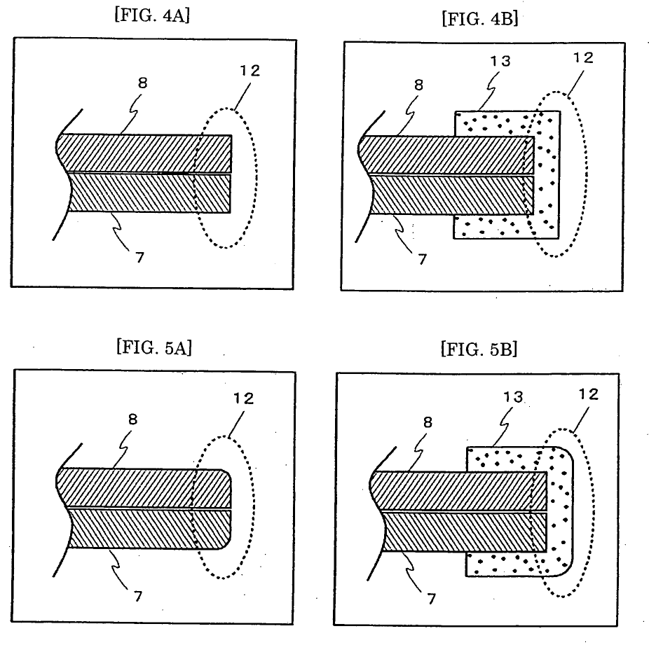

Next, an explanation will be given of the cross sectional shape of the opening edges 12 using FIGS. 4A to 5B.

As shown in FIG. 4A, the front edge of the reflecting plate 7 and the front edge of the sound waves introduction plate 8 are joined together with the positions of the respective tip ends aligned in order to form the edge 12 of the opening 6. The cross section of this edge 12 of the opening 6 has an acute corner, thereby making it easy to cause a diffraction effect in the corner when sound waves from the noise source impact the opening edge 12.

FIG. 4B shows an example in which the front edge of the reflecting plate 7 and the front edge of the sound waves introduction plate 8 are joined together with the positions of the respective tip ends aligned, and in which a cap member 13 is fitted onto the tip end of the front end portion of the joined reflecting plate 7 and sound waves introduction plate 8. The front end portion of this cap member 13 becomes the edge 12 of the opening 6, and the cross section of the outer surface of the portion of the cap member 13 that becomes the edge 12 has an acute corner. In the example shown in FIG. 4B, the thickness of the opening edge 12 is increased, as compared with the case in FIG. 4A, by the thickness of the cap member, as a result, slight disadvantage arises in generating diffraction, but by using a resin or the like as the material for the cap member 13, accidents causing injury can be reduced.

The opening edge 12 shown in FIG. 4A forms an opening edge 12 having an acute corner on the tip end thereof by joining the front edge of the reflecting plate 7 and the front edge of the sound waves introduction plate 8 in an exposed state, thus there is an advantage in generating diffraction, but it can not be said that this structure is sufficiently safe (for prevention of accidents causing injury). Thus, as shown in FIG. 5A, the opening edge 12 may be rounded to reduce the possibility of accidents causing injury only to the extent that the corner of the opening edge 12 does not negatively influence the generation of a diffraction effect.

In the same manner, in the example of FIG. 4B, the opening edge 12 of the cap portion 13 is given an acute corner, however, as shown in FIG. 5B, the opening edge 12 may be rounded to reduce the possibility of accidents causing injury only to the extent that the corner of the opening edge 12 does not negatively influence the generation of a diffraction effect.

Next an explanation will be given of the noise reduction operation of the present invention.

First, noise sound waves generated by a noise source (not shown) and reaching the noise reduction device 1 impact the edges 12 of the plurality of openings 6 arranged from the front portion to the upper portion of the body casing 2, where a diffraction phenomenon is generated due to the Huygens' Principle. Edges 12 of the openings 6 in which a diffraction phenomenon is generated become a new sound source, and sound waves advance towards the sound waves introduction openings 10 along the surface of the sound waves introduction plates 8 while the sound waves diffract, and enter the noise reduction chamber 9 after reaching the sound waves introduction openings 10.

Sound waves that enter the noise reduction chamber 9 impact the sound absorbing material 11 and lose their energy, or repeatedly reflect irregularly inside the noise reduction chamber 9 so that waves, having phase lags which allow their respective energies to be counteracted, meet with one another, as a result the noise sound energy released from the noise source is reduced.

Note that, as a plurality of openings 6 are consecutively arranged from the front portion to the upper portion of the body casing 2, noise sound waves generated by the noise source first reach one opening 6 positioned on the front portion of the body casing 2 and impact the edge 12 of that opening 6, where the sound waves diffract. On the other hand, sound waves that advance without being diffracted by the one opening 6 and reach an opening 6 that is immediately above the one opening 6, impact the edge 12 of this opening 6, where diffraction is caused. In the same manner, sound waves that leak, without causing diffraction at one opening 6, reach the opening 6 positioned immediately above the one opening 6 where a diffraction phenomenon is generated. In this manner, generation of diffraction phenomenon is repeated. Also, at this time, a portion of the sound waves that pass through the sound waves introduction plate 8 of each opening 6 without diffracting impact the reflecting plates 7 and reflect towards the sound waves introduction openings 10 (positioned at the focal points f2 on the ellipses of the reflecting plates 7). As a result, sound waves are introduced into the noise reduction chamber 9, not just due to a diffraction effect, but also due to a reflection effect.

The cross section of the reflecting plates 7 in the noise reduction device according the previously described first embodiment has an elliptical shape, however, in place of an ellipse, a curve such as a circle, a parabola, or a hyperbola can also be employed. In those cases it is preferable to match the positions of the sound waves introduction openings 10 to the focal points of the curves.

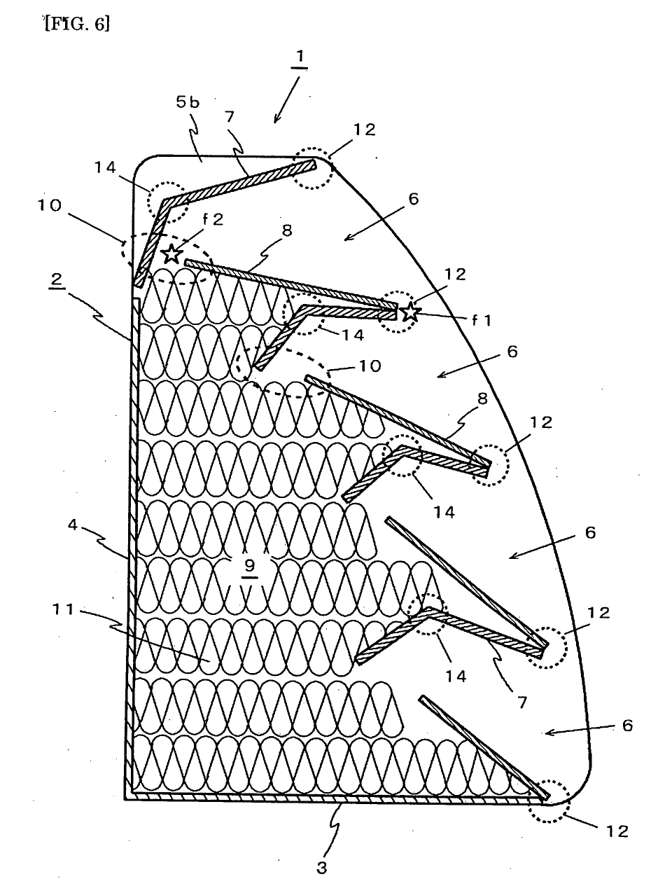

Next an explanation will be given of a second embodiment of the present embodiment using FIG. 6.

In this embodiment, the cross sectional shape of the reflecting plates 7 differs from the shape in the first embodiment, however, in all other respects, the structure of the second embodiment is the same as the structure of the first embodiment.

In this embodiment, the reflecting plates 7 do not have a cross section of an elliptical shape as in the first embodiment but are formed by bending a flat plate material at substantially the center position thereof. Even with the reflecting plates 7 having such a shape, noise sound waves that arrive from new sound sources generated at the edges 12, and noise sound waves that directly arrive from the noise source can still be guided to the sound waves introduction openings 10. These reflecting plates 7, in contrast to the reflecting plates 7 having a cross section of an elliptical shape and shown in FIG. 2, do not have focal points, as a result, it is not necessary to pay attention to the attachment positions of the opening edges 12 or the sound waves introduction openings 10 in determining where to attach the reflecting plates 7, and thus a relatively unconfined design is made possible. Note that the a bending portion 14 of the flat plate material for forming the reflecting plates 7 is not limited to one location per plate, but may also be formed at a plurality of locations and further this flat plate material may also be bent at any appropriate locations.

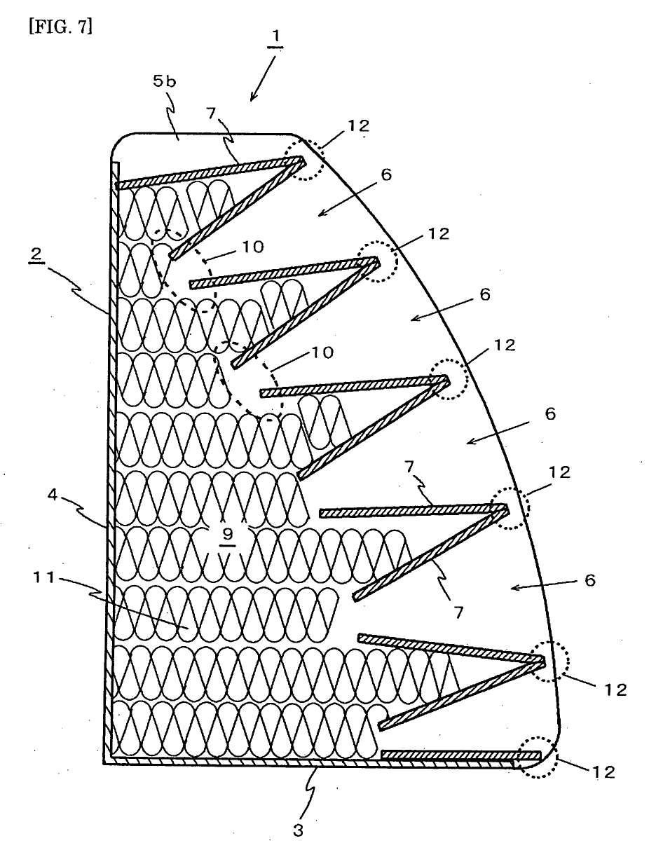

Next an explanation will be given of a third embodiment of the noise reduction device of the present invention using FIG. 7.

In this embodiment, the cross sectional shape of the reflecting plates 7 differs from the shape in the first embodiment, however, in all other respects, the structure of the third embodiment is the same as the structure of the first embodiment.

In this embodiment, the reflecting plates 7 are formed of flat plates, and a pair of reflecting plates 7 are joined at the tip ends thereof to form a V shape, and a plurality of pairs of reflecting plates 7, which are combined to form a V shape, are disposed in the body casing 2 to form a plurality of openings 6. More specifically, one opening 6 is formed from one pair of reflecting plates 7 which are combined to form a V shape, and another adjoining pair of reflecting plates 7 which are combined to form a V shape. The joining portions of the pairs of reflecting plates 7 which are combined to form a V shape form the edges 12 of the openings 6.

The openings 6, as described above, are formed by disposing pairs of reflecting plates 7 which are combined to form a V shape so that the joining portions of the pairs of reflecting plates 7 face forward, as a result, the cross sectional area of the openings 6 gradually becomes smaller toward the sound waves introduction openings 10 from the opening edges 12 of the opening 6. Moreover, the edges 12 of the openings 6 are formed, so as to form acute corner, on the tip ends of the portions where neighboring two plate materials that form the reflecting plates 7 join together, as a result, noise sound waves reaching the noise reduction device 1 from an outside noise source impact the corners of the edges 12 of the openings 6 and generate a new sound source due to the Huygens' Principle. Then the sound waves proceed along the surfaces of the reflecting plates 7, with the edges 12 serving as diffraction points, and enter the noise reduction chamber 9 through the sound waves introduction openings 10. On the other hand, noise sound waves that directly enter the openings 6 without impacting the opening edges 12 are guided into the noise reduction chamber 9 while repeatedly reflecting on the surfaces of neighboring two reflecting plates 7 of which gap gradually narrows toward the sound waves introduction openings 10, and then noise reduction takes place in the noise reduction chamber 9. Moreover, noise sound waves that directly enter the openings 6 have higher pressures as they approach the sound waves introduction openings 10, since the gap between neighboring two reflecting plates 7 gradually narrows toward the sound waves introduction openings 10, with the result that when the noise sound waves reach the sound waves introduction openings 10, a phenomenon is generated in which the noise sound waves enter the noise reduction chamber 9 at a stroke owing to the raised sound pressure. Then the noise sound waves impact the sound absorbing material 11 while relieving the sound pressure thus raised, as a result, irregular reflection of the noise sound waves is promoted and the noise reduction effect is increased.

The area of the openings of the sound waves introduction openings 10 in this third embodiment is also smaller relative to the area of the openings 6 which open towards the front surface side of the body casing 2, thus the possibility of sound waves that have entered the noise reduction chamber 9 leaking out from the noise reduction chamber 9 (returning to the front surface side) is small.

Note that, though not shown in the drawings, it is preferable that the edge shapes of the opening edges 12 in this third embodiment also have a shape having an acute corner or a rounded corner, in the same manner as in the first embodiment.

What is claimed is:

1. A noise reduction device for reducing the sound pressure of noise arriving from a noise source, comprising:
a body casing which comprises a space having a predetermined volume on an inner side thereof;
a noise reduction chamber which is formed in the inner side space of the body casing, and which houses sound absorbing material; and
a plurality of plate members extending, in the inner portion of the body casing, from the noise reduction chamber to the front surface of the body casing, wherein
an opening, formed by one plate member and another plate member that faces the one plate member, communicates with the noise reduction chamber from the front surface of the body casing, and the cross section of an edge portion of the opening is shaped to have a corner that can generate a diffraction phenomenon for a sound wave.

2. The noise reduction device according to claim 1, wherein the cross-section shape of the edge portion of the opening includes an acute corner shape.

3. The noise reduction device according to claim 1, wherein the cross-section shape of the edge portion of the opening includes a rounded corner shape.

4. The noise reduction device according to claim 1, wherein the cross section of the plate members is a continuous curve.

5. The noise reduction device according to claim 1, wherein the cross section of the plate members is an approximate curve formed by consecutively bending a straight line.

6. The noise reduction device according to claim 1, wherein the plate members are flat plates having at least one bent portion.

7. A noise reduction device for reducing the sound pressure of noise arriving from a noise source, comprising:
a body casing which comprises a space having a predetermined volume on an inner side thereof;
a noise reduction chamber which is formed in the inner side space of the body casing, and which houses sound absorbing material; and
pairs of plate members each extending, in the inner portion of the body casing, from the noise reduction chamber to the front surface of the body casing, wherein
plate members that constitute a pair are joined together at the tip ends thereof to form a V shape and are disposed in the body casing such that the tip ends of the paired plate members face the front surface side of the body casing and the rear ends of the paired plate members face the noise reduction device side, and
an opening, which communicates with the noise reduction chamber from the front surface of the body casing, is formed by one plate member of a pair of plate members and one plate member in an adjoining pair of plate members, and the cross sectional area of this opening gradually becomes smaller from an edge portion of the opening towards the noise reduction chamber rearwards.
